(19) United States
(12) Patent Application Publication
(10) Pub. No.: US 2018/0096378 A1
(43) Pub. Date: Apr. 5, 2018

(54) MONITORING DORMANT ACCOUNTS FOR RESURRECTION IN AN ONLINE SYSTEM

(71) Applicant: Facebook, Inc., Menlo Park, CA (US)

(72) Inventors: Ryan Joseph Moniz, Mountain View, CA (US); Farid Mehovic, Sunnyvale, CA (US)

(21) Appl. No.: 15/285,425

(22) Filed: Oct. 4, 2016

(51) Int. Cl. G06Q 30/02; H04L 12/26; H04L 29/08

(52) U.S. Cl. CPC G06Q 30/0242; H04L 67/22; H04L 43/0876

(57) ABSTRACT

An online system manages online accounts for a number of content providers and monitors them for lack of activity. For such online accounts, the online system determines whether the content provider of the account had a content item that performed relatively well, e.g., as measured by comparing the past performance of the sponsored content item against a benchmark, such as a percentile of a cost-per-objective metric for a country, page category, and objective type. If the past performance exceeds the threshold, the online system generates a recommendation message to the content provider that communicates that the past campaign performed particularly well and that contains a link to purchase another sponsored content item.

### BACKGROUND

This disclosure relates generally to monetization using distribution of sponsored content item, and in particular, to monitoring of the activity of online accounts for a dormancy period.

An online system allows its users to connect and communicate with each other. The online system presents content items to its users based on one or more targeting criteria determined based on the anticipated reach to its users. The online system allows content providers to distribute sponsored content items to the users for monetization purposes. The online system generates revenue from the content providers based on the performance of the sponsored content item distributed to the users. However, the conventional methods used by the online system to set a price to distribute the sponsored content items from accounts associated with content providers have no bias toward accounts that underperform due to lack of spending. Therefore, the online system sets the same price for distributing the sponsored content items for all the accounts associated with each of the content providers irrespective of the lack of spending by the account. For example, an account that performs relatively poor may still be paying a higher price to deliver the sponsored content item to the users due to an inaccurate target audience as determined by the online system.

Accordingly, the online system currently lacks a method to monitor the activity of accounts that perform below an expectation for performance as set by the online system.

### SUMMARY

An online system maintains accounts associated with multiple content providers. The online system monitors the activity of accounts for dormancy exceeding a threshold dormancy period. For example, a dormant account may be an account with no activity for the past seven days.

The online system determines a past performance metric for the monitored account based on a performance benchmark associated with a set of cost information. For example, the performance benchmark may be associated with the performance of a sponsored content item associated with the monitored account in one or more countries, a category of page visited by a user, an objective associated with the sponsored content item, etc. In some embodiments, the performance benchmark indicated by a percentile score is generated by the online system based on a country score, a page category score, and an objective score.

The online system compares the determined past performance metric for the monitored account against the performance benchmark for other accounts to determine that the past performance metric exceeded a performance threshold. The online system generates a recommendation message if the past performance metric exceeds a threshold and the monitored account exceeds the threshold dormancy period.

In some embodiments, the online system determines the past performance metric by performing a set of steps, including, but not restricted to, retrieving a cost information of sponsored content items from an account, comparing the cost information with the performance benchmark, and generating the past performance metric based on the comparison. For example, the cost information can be based on a cost-per-objective, a cost-per-engagement, and a cost-per-click.

### BRIEF DESCRIPTION OF THE DRAWINGS

FIG. 1 is a high level block diagram of a system environment for an online system, in accordance with an embodiment of the disclosure.

FIG. 2 is an example block diagram of the online system of FIG. 1, in accordance with an embodiment of the disclosure.

FIG. 3 is a block diagram of a performance analyzer of FIG. 2, in accordance with an embodiment of the disclosure.

FIG. 4 is a process of resurrection of sponsored content item, in accordance with an embodiment of the disclosure.

FIG. 5 is a process of determining a past performance metric for an account, in accordance with an embodiment of the disclosure.

FIG. 6 is an example of the process of resurrection of sponsored content item, in accordance with an embodiment of the disclosure.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

System Environment

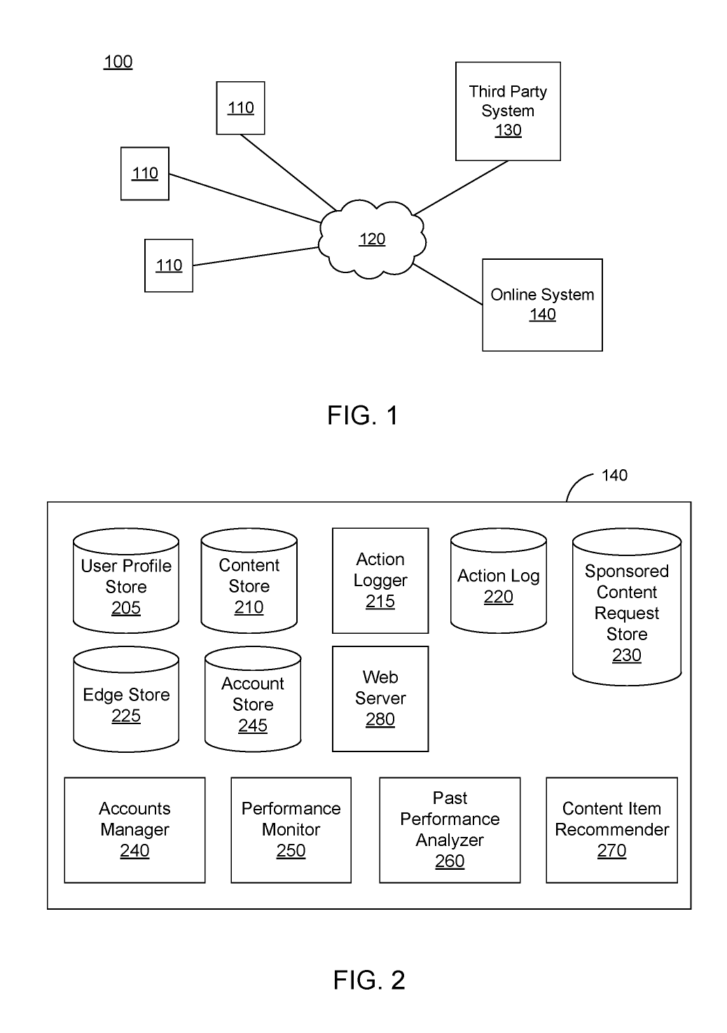

FIG. 1 is a high level block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein can be adapted to online systems that are not online systems.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as sponsored content items, content, or information about an application provided by the third party system 130.

FIG. 2 is an example block diagram of the online system 140. The online system 140 shown in FIG. 2 includes a user profile store 205, a content store 210, an action logger 215, an action log 220, an edge store 225, a sponsored content request store 230, an accounts manager 240, an accounts tore 245, a performance monitor 250, a past performance analyzer 260, a content item recommender 270, and a web server 280. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding user of the online system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 140 displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores object that each represents various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system, events, groups or applications. In some embodiments, objects are received from third-party applications or third-party applications separate from the online system 140. In one embodiment, objects in the content store 210 represent single pieces of content, or content “items.” Hence, users of the online system 140 are encouraged to communicate with each other by posting text and content items of various types of media through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions are stored in the action log 220. Examples of interactions with objects include: commenting on posts, sharing links, and checking-in to physical locations via a mobile device, accessing content items, and any other interactions. Additional examples of interactions with objects on the online system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with sponsored content items on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website that primarily sells sporting equipment at bargain prices may recognize a user of a online system 140 through a social plug-in enabling the e-commerce website to identify the user of the online system 140. Because users of the online system 140 are uniquely identifiable, e-commerce websites, such as this sporting equipment retailer, may communicate information about a user's actions outside of the online system 140 to the online system 140 for association with the user. Hence, the action log 220 may record information about actions users perform on a third party system 130, including webpage viewing histories, sponsored content items that were engaged, purchases made, and other patterns from shopping and buying.

In one embodiment, an edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system, sharing a link with other users of the online system, and commenting on posts made by other users of the online system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's affinity for an object, interest, and other users in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more sponsored content item requests (“ad requests”) are included in the sponsored content request store 230. A sponsored content item request includes sponsored content item and a bid amount. The sponsored content item content is text, image, audio, video, or any other suitable data presented to a user. In various embodiments, the sponsored content item content also includes a landing page specifying a network address to which a user is directed when the sponsored content item is accessed. The bid amount is associated with a sponsored content item by a sponsored content item provider and is used to determine an expected value, such as monetary compensation, provided by a sponsored content item provider to the online system 140 if the sponsored content item is presented to a user, if the sponsored content item receives a user interaction, or based on any other suitable condition. For example, the bid amount specifies a monetary amount that the online system 140 receives from the sponsored content item provider if the sponsored content item is displayed and the expected value is determined by multiplying the bid amount by a probability of the sponsored content item being accessed.

Additionally, a sponsored content item request may include one or more targeting criteria specified by the sponsored content item provider. Targeting criteria included in a sponsored content item request specify one or more characteristics of users eligible to be presented with content in the sponsored content item request. For example, targeting criteria are a filter to apply to fields of a user profile, edges, and/or actions associated with a user to identify users having user profile information, edges or actions satisfying at least one of the targeting criteria. Hence, the targeting criteria allow a sponsored content item provider to identify groups of users matching specific targeting criteria, simplifying subsequent distribution of content to groups of users.

In one embodiment, the targeting criteria may specify actions or types of connections between a user and another user or object of the online system 140. The targeting criteria may also specify interactions between a user and objects performed external to the online system 140, such as on a third party system 130. For example, the targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in the targeting criteria allows advertisers to further refine users eligible to be presented with content from a sponsored content item request. As another example, targeting criteria may identify users having a connection to another user or object or having a particular type of connection to another user or object.

The accounts manager 240 maintains accounts associated with content providers of the online system 140. In some embodiments, the accounts manager 240 tags each of the maintained accounts with a name associated with the content provider. The accounts store 245 stores the information associated with each of the accounts maintained by the accounts manager 240. For example, the accounts store 245 may store the tagged name of the account, a timestamp corresponding to a last activity on the account, event information corresponding to the last activity, etc.

The accounts store 245 stores a set of cost information associated with each of the sponsored content item from the maintained account. For example, the cost information can include a cost-per-objective, a cost-per-engagement, and a cost-per-click. The cost-per-objective is a cost for an objective including, but not restricted to, an app install, a product catalog promotion, a lead generation, a video view, etc. The cost-per-engagement is a cost for an engagement, including, but not restricted to, an app engagement, a page post engagement, event responses, etc. The cost-per-click is a cost for a click, including, but not restricted to, a click to a website, a website conversion, a page like, etc. The accounts store 245 also stores the sponsored content items from the accounts maintained by the accounts manager 240 in the past. In some embodiments, the accounts manager 240 maintains a set of accounts associated with content providers that bought sponsored content items from the accounts store 245 only in the past.

The performance monitor 250 monitors the activity of accounts maintained by the accounts manager 240. In some embodiments, the performance monitor 250 receives a set of tracking signals from the content providers that track the activity of accounts based on an occurrence of an online transaction. For example, the performance monitor 250 can monitor a number of “Ad Buys” corresponding to an account from the accounts store 245. The number of “Ad Buys” is based on a number of sponsored content items bought by a content provider for delivery to the user of the online system 140. In some embodiments, the performance monitor 250 monitors a set of tracking pixels from web pages visited by a user of the online system 140 responsive to clicking on a sponsored content item from an account maintained by the accounts manager 240.

The past performance analyzer 260 determines a past performance metric for each of the accounts in the accounts store 245. In some embodiments, the past performance analyzer 260 determines the past performance metric for the monitored account that exceeds a threshold dormancy period. For example, the past performance analyzer 260 determines the past performance metric if the performance monitor 250 monitors that the account in question remained inactive for seven consecutive days.

The past performance analyzer 260 compares the determined past performance metric for the account monitored by the performance monitor 250 against the performance benchmark associated with other accounts maintained by the accounts manager 240. The past performance analyzer 260 determines that the past performance metric exceeds a performance threshold if the determined past performance metric is different from the performance benchmark of at least one of the accounts maintained by the accounts manager 240. For example, the determined past performance metric for the monitored account may be lower than the performance benchmark associated with an account in the accounts manager 240.

In some embodiments, the past performance analyzer 260 determines the past performance metric for an account by performing a set of steps. The past performance analyzer 260 retrieves a cost information of sponsored content items from an account maintained by the accounts manager 240. The past performance analyzer 260 compares the cost information from the accounts store 245 with the performance benchmark (e.g., cost-per-objective, cost-per-engagement, and a cost-per-click).

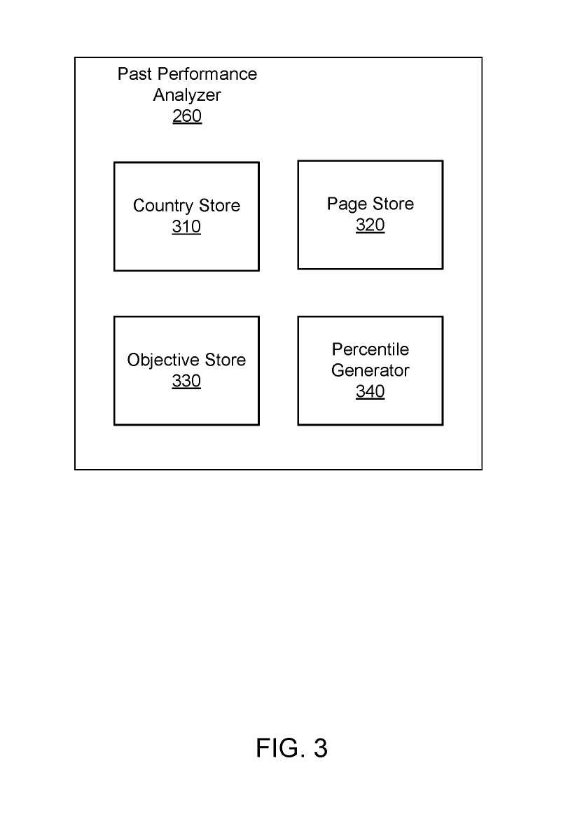

The past performance analyzer 260 determines the past performance metric based on a percentile score generated from at least a country score, a page category score, and an objective score as described below with reference to FIG. 3. In some embodiments, the past performance analyzer 260 determines the percentile score based on a weighted sum of the country score, the page category score, and the objective score. The past performance analyzer 260 determines the weight for determining the percentile score based on a set of targeting criteria defined by the online system 140.

The past performance analyzer 260 also retrieves the cost information stored by the accounts store 245. The past performance analyzer 260 compares the percentile score representing a set of performance benchmarks with the retrieved cost information. The past performance analyzer 260 generates the past performance metric based on the comparison.

In some embodiments, the past performance analyzer 260 determines the past performance metric based on the set of tracking pixels monitored by the performance monitor 250 based on a user action to a sponsored content item from the accounts manager 240.

The content item recommender 270 generates a recommendation message if the past performance metric determined by the past performance analyzer 260 exceeds a performance threshold and the performance monitor 250 determines that the monitored account exceeds a threshold dormancy period. In some embodiments, the recommendation message includes a user interface with a link to the web page that allows the creation of a new sponsored content item. In one example, the recommendation message would contain a tip message (e.g., “An action you may take!”) that prompts the content provider with a statistical performance of sponsored content items delivered in the recent past. The content item recommender 270 generates the tip message if the account in question performed at or above a threshold percentile (e.g., 70^{th} percentile) in the past. In alternate embodiments, the content item recommender 270 generates a recommendation message if the past performance metric determined by the past performance analyzer 260 exceeds a performance threshold.

The content item recommender 270 generates a recommendation message that prompts the content provider to create a new campaign based on the performance of a sponsored content item from the account monitored by the performance monitor 250 in the past. For example, the content item recommender 270 may generate a recommendation message as “Your previous campaign performed at the 85^{th} percentile when compared to our other advertisers. Would you like to create a new campaign?” In some embodiments, the content item recommender 270 generates a recommendation message that includes only the statistical performance data such as the percentile score of the monitored account.

In some embodiments, the content item recommender 270 generates the recommendation message as a newsfeed from the online system 140. In other embodiments, the content item recommender 270 generates the recommendation message in the right-hand column of the client device 110 associated with the online system 140.

The web server 280 links the online system 140 via the network 120 to the one or more client devices 110, as well as to the one or more third party systems 130. The web server 280 serves web pages, as well as other web-related content, such as JAVA®, FLASH®, XML and so forth. The web server 280 may receive and route messages between the online system 140 and the client device 110, for example, instant messages, queued messages (e.g., email), text messages, short message service (SMS) messages, or messages sent using any other suitable messaging technique. A user may send a request to the web server 280 to upload information (e.g., images or videos) that are stored in the content store 210. Additionally, the web server 280 may provide application programming interface (API) functionality to send data directly to native client device operating systems, such as IOS®, ANDROID™, WEBOS® or RIM®.

FIG. 3 is a block diagram of the past performance analyzer 260 of FIG. 2, in accordance with an embodiment of the disclosure.

The past performance analyzer 260 determines the past performance metric based on a performance benchmark. The past performance analyzer 260 comprises a country store 310, a page store 320, an objective store 330, and a percentile generator 340.

The country store 310 stores information associated with a performance benchmark determined by the online system 140 from each country that received a sponsored content item delivered by an account associated with the content provider in the past. For example, the country store 310 stores a country score (e.g., 9 out of 10) based on a performance of a sponsored content item delivered to a set of target audience in the US. The country store 310 stores another country score (e.g., 8.5 out of 10) based on the performance of the sponsored content item in China.

The page store 320 stores information associated with a performance benchmark determined by the online system 140 from each category of page visited by a user based on a sponsored content item delivered by an account associated with the content provider in the past. For example, the page store 320 stores information related to each category of pages visited by the user responsive to a sponsored content item about pet food. The page store 320 stores a page score (e.g., 8 out of 10) for a page about a pet store, and a page score (e.g., 7 out of 10) for a page about pet insurance. The page store 320 stores each of the page category scores as a performance benchmark to determine a past performance metric for an account associated with the content provider.

The objective store 330 stores information associated with a performance benchmark determined by the online system 140 from the objective associated with a sponsored content item delivered by an account associated with the content provider in the past. For example, the objective store 330 stores an objective score (e.g., 9 out of 10) when a user installed an app on the client device 110 responsive to the sponsored content item associated with the installed app delivered by the account.

The percentile generator 340 generates a percentile score based on the information stored by the country store 310, the page store 320 and the objective store 330. In some embodiments, the percentile generator 340 generates a combined percentile score as a weighted sum of the country score, the page category scores, and the objective score. For example, the percentile generator 340 generates a combined percentile score of 70 by summing up a country score of 30, a page category score of 25, and an objective score of 15. In alternate embodiments, the percentile generator 340 generates the combined percentile score by applying different weights for each of the country score, the page category score, and the objective score.

In some embodiments, the past performance analyzer 260 determines the past performance metric as a ratio of the cost information (e.g., cost-per-objective) retrieved from the account store 245 of FIG. 2 to the percentile score generated by the percentile generator 340. For example, a past performance metric of 10 corresponds to a cost-per-objective of 7 units to a percentile score of 0.7.

### Resurrection of Sponsored Content Item

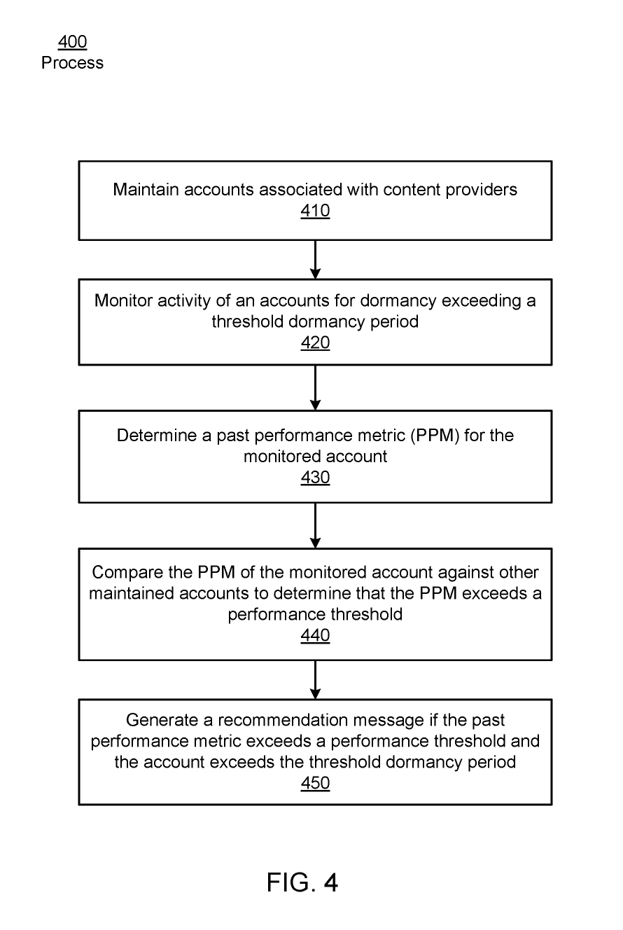

FIG. 4 is a process of resurrection of sponsored content item, in accordance with an embodiment of the disclosure.

The online system 140 maintains 410 accounts associated with the content providers. For example, the accounts manager 240 of FIG. 2 maintains accounts tagged with names of the content providers as stored by the account store 245.

The online system monitors 420 the activity of accounts for dormancy exceeding a threshold dormancy period. For example, the performance monitor 250 of FIG. 2 monitors the last activity of the accounts and determines a threshold dormancy period based on a timestamp associated with the last activity on the account.

The online system 140 determines 430 a past performance metric if the account exceeds the threshold dormancy period. For example, the past performance analyzer 260 of FIG. 2 determines the past performance metric if the account exceeds a dormancy period of seven consecutive days.

The online system 140 compares 440 the past performance metric determined by the past performance analyzer 260 against the performance benchmark associated with other accounts maintained by the accounts manager 240 to determine that the past performance metric exceeds a performance threshold.

The online system 140 generates 450 a recommendation message if the past performance metric exceeds a performance threshold (e.g., a percentile score) and the account exceeds the threshold dormancy period. For example, the content item recommender 270 of FIG. 2 generates a recommendation message with a link to create a new campaign if the past performance metric exceeds a 70^{th} percentile based on the past performance of the sponsored content items and the performance monitor 250 of FIG. 2 monitors a lack of activity for the past seven days.

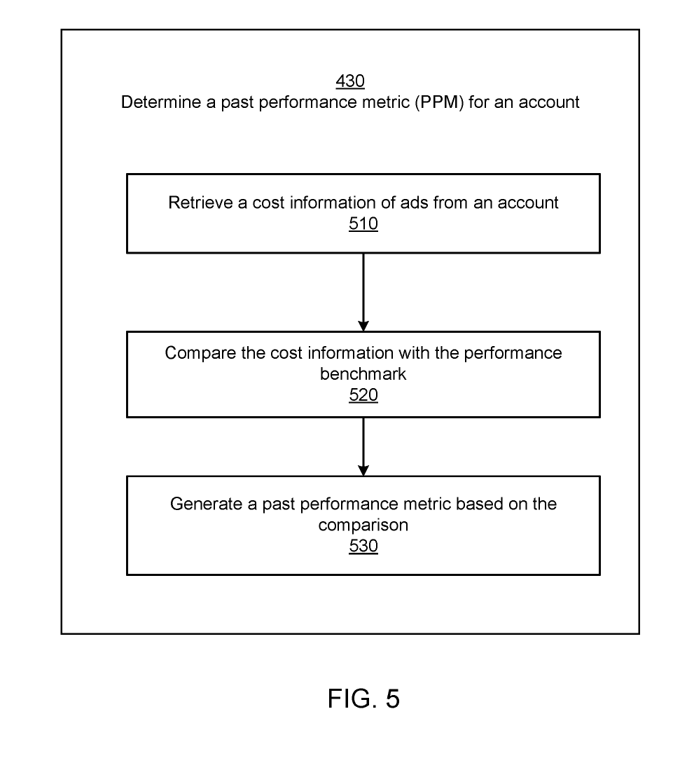

FIG. 5 is a process of determining a past performance metric for an account, in accordance with an embodiment of the disclosure.

The online system 140 retrieves 510 cost information of sponsored content items from an account. For example, the past performance analyzer 260 retrieves a cost-per-objective of sponsored content items from the accounts store 245 of FIG. 2.

The online system 140 compares 520 the cost information with the performance benchmark. For example, the past performance analyzer 260 of FIG. 2 compares the cost-per-objective from the accounts store 245 with the percentile score generated by the percentile generator 340 of FIG. 3.

The online system 140 generates 530 a past performance metric based on the comparison. For example, the past performance analyzer 260 of FIG. 2 generates a past performance metric of an account of 0.5 indicating a ratio of the cost-per-objective to the generated percentile score.

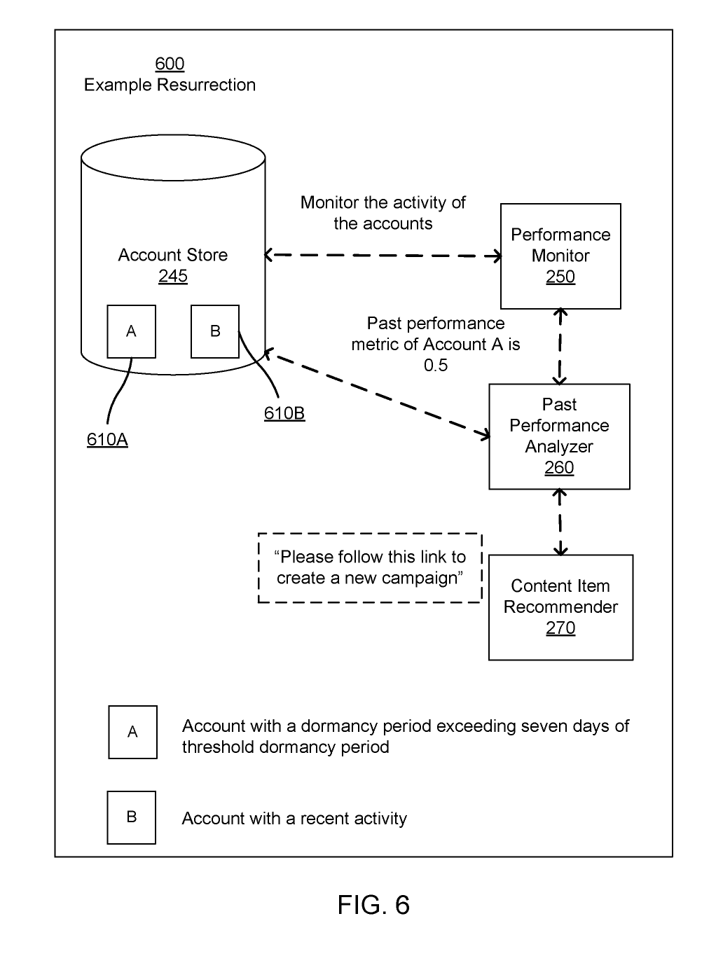

FIG. 6 is an example 600 of the process of resurrection of sponsored content items, in accordance with an embodiment of the disclosure. As described above with reference to FIG. 2-3, the example 600 shows the communication between the account store 245, the performance monitor 250, the past performance analyzer 260, and the content item recommender 270. The accounts store 245 in the example 600 includes an account 610B with a recent activity and an account 610A with a dormancy period exceeding seven days as monitored by the performance monitor 250. The past performance analyzer 260 of FIG. 2 determines a past performance metric of the account 610A as 0.5 based on the comparison of the past performance metric using the cost information from the account store 245 with the performance benchmarks of other accounts in the accounts store 245 using the percentile score generated by the past performance analyzer 260. The content item recommender 270 of FIG. 2 communicates with the past performance analyzer 260 and generates a recommendation message “Please follow this link to create a new campaign” prompting the content provider based on the past performance of sponsored content items associated with the account 610A.

### CONCLUSION

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments of the disclosure is intended to be illustrative, but not limiting, of the scope of the disclosure, which is set forth in the following claims.

What is claimed is:

1. A method comprising:
maintaining, by an online system, a plurality of accounts associated with a plurality of content providers;
monitoring an activity of at least one of the plurality of accounts for dormancy exceeding a threshold dormancy period;
determining a past performance metric for the monitored account based on a performance benchmark;
comparing the determined past performance metric for the monitored account against the performance benchmark for the plurality of accounts to determine that the determined past performance metric exceeds a performance threshold; and
generating a recommendation message responsive to the activity of the monitored account exceeding the threshold dormancy period and the determined past performance metric exceeding a performance threshold.

2. The method of claim 1, wherein determining the past performance metric further comprises:
retrieving a cost information associated with one or more past sponsored content items associated with the monitored account;
comparing the retrieved cost information with a performance benchmark determined by the online system; and
generating the past performance metric for the monitored account based on the comparison.

3. The method of claim 1, wherein the past performance metric is based on a country score associated with a performance of the monitored account in one or more countries.

4. The method of claim 1, wherein the past performance metric is based on a page category score determined based on one or more categories of pages visited by a user responsive to a sponsored content item from the monitored account.

5. The method of claim 1, wherein the past performance metric is based on an objective score determined based on a user responding to an objective associated with a sponsored content item from the monitored account.

6. The method of claim 1, wherein the recommendation message comprises a user interface including a link to create a content item for a new online campaign.

7. The method of claim 1, wherein the recommendation message includes the determined past performance metric associated with the monitored account.

8. The method of claim 6, wherein the recommendation message is generated responsive to the past performance metric exceeding a percentile score.

9. The method of claim 1, wherein the online system determines the past performance metric based on a set of tracking information received from the plurality of content providers based on an action performed by a user on the online system.

10. The method of claim 2, wherein the cost information is based at least in part on a cost-per-objective, cost-per-engagement, and a cost-per-click.

11. A method comprising:
maintaining, by an online system, a plurality of accounts associated with a plurality of content providers;
monitoring an activity of at least one of the plurality of accounts for dormancy exceeding a threshold dormancy period;
for each of the plurality of content providers:
in response to the activity of the monitored account exceeding the threshold dormancy period,
retrieving a cost information associated with each of the plurality of accounts;
comparing the retrieved cost information with a set of benchmarks determined by the online system;
determining a past performance metric for each of the plurality of accounts based on the comparison;
comparing the determined past performance metric for the monitored account against the performance benchmark for the plurality of accounts to determine that the determined past performance metric exceeds a performance threshold; and
generating a recommendation message responsive to the determined past performance metric exceeding a performance threshold.

12. The method of claim 11, wherein the past performance metric is based on a country score associated with a performance of the monitored account in one or more countries.

13. The method of claim 11, wherein the past performance metric is based on a page category score determined based on one or more categories of pages visited by a user responsive to a sponsored content item from the monitored account.

14. The method of claim 11, wherein the past performance metric is based on an objective score determined based on a user responding to an objective associated with a sponsored content item from the monitored account.

15. The method of claim 11, wherein the recommendation message comprises a user interface including a link to create a content item for a new online campaign.

16. The method of claim 11, wherein the recommendation message includes the determined past performance metric associated with the monitored account.

17. The method of claim 15, wherein the recommendation message is generated responsive to the past performance metric exceeding a percentile score.

18. The method of claim 11, wherein the online system determines the past performance metric based on a set of tracking information received from the plurality of content providers based on an action performed by a user on the online system.

19. The method of claim 11, wherein the cost information is based at least in part on a cost-per-objective, cost-per-engagement, and a cost-per-click.

20. A computer program product comprising a non-transitory computer-readable storage medium containing computer program code which when executed by one or more processors causes the one or more processors to perform operations comprising:
maintain, by an online system, a plurality of accounts associated with a plurality of content providers;
monitor an activity of at least one of the plurality of accounts for dormancy exceeding a threshold dormancy period;
for each of the plurality of content providers:
in response to the activity of the monitored account exceeding the threshold dormancy period,
retrieve a cost information associated with each of the plurality of accounts;
compare the retrieved cost information with a set of benchmarks determined by the online system;
determine a past performance metric for each of the plurality of accounts based on the comparison;
compare the determined past performance metric for the monitored account against the performance benchmark for the plurality of accounts to determine that the determined past performance metric exceeds a performance threshold; and
generate a recommendation message responsive to the determined past performance metric exceeding a performance threshold.
